(19) United States
(12) Patent Application Publication
(10) Pub. No.: US 2023/0276837 A1
(43) Pub. Date: Sep. 7, 2023

(54) PROCESS FOR PREPARING BATTERED FOOD

(71) Applicant: R&D Coating Solutions LLC, Yukon, OK (US)

(72) Inventor: Donald R. Maxedon, Yukon, OK (US)

(21) Appl. No.: 17/931,995

(22) Filed: Sep. 14, 2022

Related U.S. Application Data
(63) Continuation-in-part of application No. 17/690,801, filed on Mar. 9, 2022.
(60) Provisional application No. 63/159,713, filed on Mar. 11, 2021.

(51) Int. Cl. A23P 20/10; A23L 3/36; A23P 20/15; A23P 20/13

(52) U.S. Cl. CPC A23P 20/11; A23L 3/36; A23P 20/15; A23P 20/13

(57) ABSTRACT

A battering process for providing a battered food product including the steps of coating a food product with a predust and a dry batter prior to misting the food product with a combination of water, oil, and an emulsifier to form an edible coating on the food product. Setting the edible coating on the food product in a steam oven before thermally processing the food product, misting the edible coating on the food product with water, and freezing and packing the food product to be reheated.

### CROSS-REFERENCE TO RELATED APPLICATIONS

This application is a continuation-in-part of U.S. Ser. No. 17/690,801, filed on Mar. 9, 2022; which claims benefit to U.S. Provisional Application No. 63/159,713, filed on Mar. 11, 2021; the entire contents of each being hereby expressly incorporated herein by reference.

### BACKGROUND

Batter fried foods have enjoyed sustained popularity across many food cultures around the world. Consumers of breaded foods are likely drawn to their unique texture and golden-brown appearance. However, achieving this desired texture and appearance requires labor intensive processes that employ different types of animal fats and/or vegetable oils.

Typically, fried and battered foods are prepared, for example, by coating food products with a flour-based mixture, followed by a flour-based batter, before submerging the coated food products in heated animal fats and/or vegetable oils to achieve the desired texture and golden-brown appearance sought after by consumers.

Increasingly, however, more health-conscious consumers are turning away from fried, battered foods because fried, battered foods are highly caloric and contain high levels of fats. This is largely due to the methods of preparing fried, battered foods. In recognition of the changing dietary preferences of consumers, manufacturers and other commercial preparers of food products have sought to obtain similar texture, flavor, and appearance of fried, battered foods without the typical oil-frying process. This includes the use of different coatings for food products that, when prepared, attempt to imitate the characteristics of traditionally fried, battered food products. However, these attempts have been met with varying degrees of success. Often, these new processes do not produce food products having the appearance, texture, or taste of fried products. These new processes typically rely on the use of a liquid batter to coat the food product. However, the fluidity of a liquid batter often causes the liquid batter to drip off the food product after it has been coated. The liquid batter drippings impact the efficiency of food production machinery and can cause considerable waste of ingredients.

A need exists for a coating for food products and process of producing food products having the taste, texture, and appearance of fried, battered food without relying on traditional oil-frying methods and the use of liquid batters. It is to such a coating and process of preparing food products employing the coating that the inventive concepts disclosed and claimed herein are directed.

### SUMMARY OF THE INVENTIVE CONCEPTS

The inventive concepts disclosed and claimed herein generally relate to a breading process for producing battered food products. The process includes coating a food product with a predust comprising cracker meal and one or more other natural coating ingredients in a predust step. Following the predust step, misting the food product with water and oil in a first misting step. Next, coating the food product from the first misting step with a dry batter comprising dry ingredients and oil in a coating step. Then, misting the food product from the coating step with water, oil, and an emulsifier in a second misting step to form an edible coating on the food product. Following the second misting step, setting the edible coating on the food product in a steam oven in a setting step. Next, thermally processing the food product from the setting step in a cooking step before misting the edible coating on the food product from the cooking step with water in a third misting step, and freezing the food product from the third misting step for packaging.

### BRIEF DESCRIPTION OF THE DRAWINGS

To assist those of ordinary skill in the art in making and using the inventive concepts disclosed herein, reference is made to the appended drawings.

FIG. 1 is a flowchart illustrating steps to coat a food product according to an exemplary embodiment of the inventive concepts disclosed herein.

FIG. 2 is a flowchart illustrating steps to coat a food product using a dry batter according to an exemplary embodiment of the inventive concepts disclosed herein.

### DETAILED DESCRIPTION OF EXEMPLARY EMBODIMENTS

Before explaining at least one embodiment of the inventive concept(s) in detail by way of exemplary drawings, experimentation, results, and laboratory procedures, it is to be understood that the inventive concept(s) is not limited in its application to the details of construction and the arrangement of the components set forth in the following description or illustrated in the drawings, experimentation and/or results. The inventive concept(s) is capable of other embodiments or of being practiced or carried out in various ways. The language used herein is intended to be given the broadest possible scope and meaning; and the embodiments are meant to be exemplary-not exhaustive. Also, it is to be understood that the phraseology and terminology employed herein is for the purpose of description and should not be regarded as limiting.

Unless otherwise defined, scientific and technical terms used in connection with the presently disclosed and claimed inventive concept(s) shall have the meanings commonly understood by those of ordinary skill in the art. Further, unless otherwise required by context, singular terms shall include pluralities and plural terms shall include the singular. The foregoing techniques and procedures are generally performed according to conventional methods well known in the art and as described in various general and more specific references cited and discussed throughout the present specification. The nomenclatures utilized in connection with, and the laboratory procedures and techniques of, analytical chemistry, synthetic organic chemistry, and medicinal and pharmaceutical chemistry described herein are those well-known and commonly used in the art. Standard techniques are used for chemical syntheses and chemical analyses.

All the articles, compositions and/or methods disclosed and claimed herein can be made and executed without undue experimentation, given the present disclosure. While the articles, compositions and methods of the inventive concept(s) have been described in terms of preferred embodiments, it will be apparent to those of skill in the art that variations may be applied to the articles, compositions and/or methods and in the steps or in the sequence of steps of the methods described herein without departing from the concept, spirit and scope of the inventive concept(s). All such similar substitutes and modifications apparent to those skilled in the art are deemed to be within the spirit, scope and concept of the inventive concept(s) as defined by the appended claims.

As utilized under the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternatives are mutually exclusive, although the disclosure supports a definition that refers to only alternatives and “and/or.”

Throughout this application, the term “about” is used to indicate that a value includes the inherent variation of error for the device, the method being employed to determine the value, or the variation that exists among the study subjects.

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, the term “meat” refers to fish, shell-fish, poultry, beef, veal, pork, various game meats, and any other type of animal product commonly referred to as meat or fish. A meat may be available in various cuts, including with or without bones.

As used herein, the term “coating” may be one or more layers of a substance, for example a batter, breader, or predust applied to a food product. The “coating” may comprise several layers applied individually.

As used herein, the term “predust” may be a dry component of a coating. A “predust” may be applied to a food product prior to a batter or breader layer of a coating. Predust may be available in a variety of sizes, including very fine to very coarse, and may include additional ingredients such as flavorings and seasonings.

As used herein, the term “batter” may be a liquid or liquid based coating, or a coating of dry ingredients. A batter may be a suspension, emulsion, or solution of a liquid that contains a second liquid and/or a solid, such as, for example, gums, starches, or flour. A batter may further be a combination of dry ingredients and oil, which is later hydrated in the presence of moisture.

In the following detailed description of embodiments of the inventive concept, numerous specific details are set forth in order to provide a more thorough understanding of the inventive concept. However, it will be apparent to one of ordinary skill in the art that the inventive concept within the disclosure may be practiced without these specific details. In other instances, well-known features have not been described in detail to avoid unnecessarily complicating the instant disclosure.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

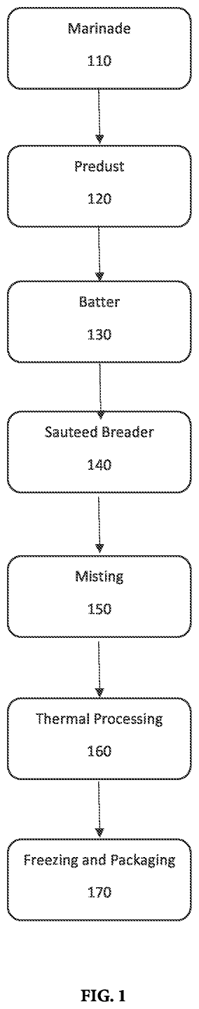

Referring now to FIG. 1, shown therein is a flowchart illustrating steps to coat a food product according to an exemplary embodiment of the inventive concepts disclosed herein.

In a step 110, a marinade is applied to a food product. The food product may be a meat, vegetable, fruit, appetizer, cheese, pasta-based food product, or a combination thereof. Generally, the size of the food product is not critical. The food products may vary from bite-sized to whole food products. The food product may also be a formed food product which is manufactured from particles of one or more food products and reformulated into particular shapes. The food product may be uniform in size or of varying sizes. The food product may also be portioned to a particular size. The food product may be fresh, frozen, or semi-frozen. The food product may be raw, cooked, or partially cooked, and may include a breaded heat set coating. The food product may be boneless or bone-in. In one embodiment, frozen food products are thawed to, for example, refrigerated temperature before the marination step 110.

The marinade applied to the food product in step 110 may impart flavor to the food product, tenderize the food product, and may introduce moisture into the food product to prevent the food product from becoming too dry once cooked. The marinade may also allow for uniformity of flavor of the food products. The marinade may be a liquid marinade, the composition of the liquid marinade may include liquid ingredients, dry ingredients, or both.

The liquid marinade may include a flavored stock, an alkali metal phosphate, and salt. The liquid marinade may contain a flavored stock, such as chicken stock, beef stock, turkey stock, vegetable stock, fish and seafood stock, bone broth, or a combination thereof. Flavored stock may impart flavor to the food product and provide moisture. The flavored stock for the liquid marinade may be salted or unsalted. The liquid marinade may comprise about 0% to 100% by weight of flavored stock. In one embodiment, the liquid marinade may comprise about 96% by weight of unsalted chicken stock.

The liquid marinade may contain alkali metal phosphates such as, for example, sodium tripolyphosphate, sodium hexametaphosphate, sodium pyrophosphate, dipotassium phosphate, or a combination thereof. The liquid marinade may comprise up to about 0.5% by food product weight of alkali metal phosphates. The liquid marinade may comprise about 0% to about 2% by weight of alkali metal phosphates. In one embodiment, the liquid marinade may comprise about 2% by weight of sodium tripolyphosphate. Sodium tripolyphosphate is commonly used in marinades to increase meat yield and water-holding capacity, as well as improve color and texture. The liquid marinade may also contain salt, such as sodium chloride. In some embodiments, the salt may be an encapsulated salt to better maintain the cellular integrity of meat proteins. The liquid marinade may comprise an amount of salt based on consumer preference. In one embodiment, the liquid marinade may comprise about 2% by weight of salt. Salt, similarly, is another common ingredient in marinades, and may enhance food product flavor, increase moisture retention, and, when used with sodium tripolyphosphate, may act as a synergist with sodium tripolyphosphate to extract salt-soluble proteins. The liquid marinade may be suitable for injection into food products. The marinade may be applied to the food product by conventional procedures known in the art, including the use of a vacuum tumbler, and needle injectors. The alkali metal phosphates and salt may be uniformly dispersed in the flavored stock to form the liquid marinade.

In one embodiment, marinating step 110 is performed in a vacuum tumbler. Vacuum tumbling is a method of marination in which food products are placed in a rotating tumbler in the presence of a marinade under reduced pressured. Applying a vacuum mechanically distorts the food product, expanding it, and allows for effective absorption of the marinade. Further, the mechanical distortion of the food product, such as meats, may break down meat fibers to enhance tenderization. Once the food products are placed into the vacuum tumbler, an amount of liquid marinade may be metered into the vacuum tumbler. An amount of liquid marinade of approximately 10% to 25% by weight of the food product may be placed into the vacuum tumbler with the food product. In one embodiment, an amount of liquid marinade, such as, about 13% by weight of the food product, may be metered into the vacuum tumbler. The food product may be tumbled in the vacuum tumbler for approximately 15-25 minutes. The food product may be marinated in the vacuum tumbler for a predetermined amount of time, or until substantially all the liquid marinade is absorbed by the food product.

In some embodiments, after marinating step 110, the food product may be tumbled in the vacuum tumbler with a liquid batter. In that embodiment, an amount of liquid batter, such as, about 10% by weight of the food product, comprising approximately 35% to 40% batter solids, may be metered into the vacuum tumbler. The food product may be tumbled in the vacuum tumbler without vacuum for approximately 5 minutes.

In another embodiment, marinating step 110 may be optional.

In an alternative embodiment, marinating step 110 may be performed by injecting the liquid marinade directly into the food product using, for example, a single needle injector or multi-needle injector. In that embodiment, the food product may be a bone-in meat product. The food product may be injected at one or more injection locations, and a desired volume of liquid marinade may be deposited at each of the one or more injection locations.

In another embodiment, after marinating step 110, the food product may be placed on a vibratory conveyor belt, which produces a vibration, or otherwise agitates the food products as the food products are being conveyed along the vibratory conveyor belt, causing the liquid marinade to be uniformly dispersed throughout the food product.

After the marination step 110, a predust may be applied to the food product in a step 120.

In step 120, a predust may be added to the vacuum tumbler to coat the food product after the marination step 110. Application of a predust to the food product may improve the adhesion of a coating, improve yield, impart flavor, and improve crispiness of a food product. The predust may contain one or more of bread crumbs, cracker meal, food starch, fiber, flour, spices, natural colors and flavors, and oil. The predust may include bread crumbs, such as American bread crumbs or Japanese bread crumbs. The bread crumbs and cracker meal may contribute to the food product's ultimate texture, flavor, and appearance. The bread crumbs may be sauteed to impart a refined sauté fried flavor and golden-brown appearance to the food product. In one embodiment, bread crumbs may be sautéed with oil using a heated plate with a surface temperature of about 400° F. The oil may be a vegetable oil, an animal fat or oil, or combination thereof. The oil may be a soy bean oil, cotton seed oil, palm kernel oil, safflower oil, corn oil, beef tallow, pork lard, goose or duck fat, or a combination thereof. The predust may also contain wheat flour, tapioca flour, rice flour, yellow corn flour or a combination thereof. Commercially available mixers, such as, for example, OptimaBlend® blenders may perform step 120. Food starch, such as natural starches, may be included in the predust for added crispiness and for improve oil-barrier properties. Similarly, natural colors may be added to the predust composition to create a uniform golden color around the food product. The predust may be formed by combining the bread crumbs, cracker meal, food starch, fibers, flour natural flavors and colors, spray dried fats, flavored meat powders, and spices. In some embodiments, the first predust may further comprise artificial flavors and colors, and antioxidants to control rancidity. The combined predust may be processed to obtain varying particle sizes. In one embodiment, the predust is a fine powder with limited bread crumbs and cracker meal.

An amount of predust may be metered into the vacuum tumbler to coat the marinated food product. In one embodiment, an amount of predust, such as, about 0% to about 2% by weight of the food product, may be metered into the vacuum tumbler. The food product may be tumbled in the vacuum tumbler with the predust for up to about 5 minutes. The food product may be coated with the predust in the vacuum tumbler for a predetermined amount of time, or until substantially all of the predust has adhered to the surface of the food product.

In an alternative embodiment, the liquid marinade and predust may be applied to the food product without a vacuum tumbler using conventional methods.

In another embodiment, the predust step 120 may be optional.

After the predust step 120, the food product may be removed from the vacuum tumbler for further processing. In a step 130, a first batter may be applied to the food product. The first batter may combine a combination of water, dry ingredients, and oil. The first batter may contain one or more of bread crumbs, food starch, flour, cracker meal, natural flavors and colors, spices, spray dried fats, flavored meat powders, oil, water, and combinations thereof. The first batter may contain bread crumbs, such as American or Japanese bread crumbs. The first batter may also contain one or more varieties of flour, such as wheat flour, tapioca flour, rice flour, yellow corn flour, or a combination thereof. The first batter may also contain, for example, natural starches, citrus fibers, natural flavors and colors, spices, spray dried fats, flavored meat powders, oil, or a combination thereof. In some embodiments, the first batter may further comprise artificial flavors and colors, and antioxidants to control rancidity. In one embodiment, the first batter may contain about 2% to about 5% by weight oil. The addition of oil to the first batter may improve the finished batter coating appearance and improve batter coating release from Teflon™ slats, such as Cambridge™ belting or JBT ProGrill™/ProBake™ belting during further processing. In on embodiment, the dry ingredients may be identical to or substantially similar to the predust formulation. The water content of the first batter may be adjusted depending on desired viscosity and coating thickness. The first batter may be applied to the food product by conventional procedures known in the art. In an alternative embodiment, the first battering step 130 may be optional.

In a step 140, a second predust may be applied to the food product after the first batter step 130. Application of the second predust to the food product may improve the adhesion of a coating, improve yield, impart flavor, improve crispiness of a food product, and create a protective seal against product leakage. The second predust may contain one or more of bread crumbs, cracker meal, food starch, fiber, flour, spices, natural colors and flavors, and oil. The second predust may include bread crumbs, such as American bread crumbs or Japanese bread crumbs. The bread crumbs may contribute to the food product's ultimate texture, flavor, and appearance. The cracker meal may be sauteed to impart a refined sauté fried flavor and golden-brown appearance to the food product. In one embodiment, the cracker meal may be sautéed with oil using a heated plate with a surface temperature of about 400° F. The oil may be a vegetable oil, an animal fat or oil, or a combination thereof. The oil may be a soy bean oil, cotton seed oil, palm kernel oil, safflower oil, corn oil, or a combination thereof. The second predust may also contain wheat flour, tapioca flour, rice flour, yellow corn flour or a combination thereof. Food starch, such as natural starches, may be included in the predust for added crispiness and for improve oil-barrier properties. Similarly, natural colors may be added to the second predust composition to create a uniform golden color around the food product. The second predust may be formed by combining the bread crumbs, cracker meal, food starch, fibers, flour natural flavors and colors, spray dried fats, flavored meat powders, and spices. In some embodiments, the second predust may further comprise artificial flavors and colors, and antioxidants to control rancidity. The combined second predust may be processed to obtain varying particle sizes. In one embodiment, the second predust is a fine powder.

In a step 150, a second batter may be applied to the food product following the second predust step 140. The second batter may combine a combination of water, dry ingredients, and oil. The second batter may contain one or more of bread crumbs, food starch, flour, cracker meal, gums, natural flavors and colors, spices, spray dried fats, flavored meat powders, oil, water, and combinations thereof. The second batter may contain bread crumbs, such as American or Japanese bread crumbs. The second batter may also contain one or more varieties of flour, such as wheat flour, tapioca flour, rice flour, yellow corn flour, or a combination thereof. The second batter may also contain, for example, natural starches, citrus fibers, natural flavors and colors, spices, spray dried fats, flavored meat powders, oil, or a combination thereof. In some embodiments, the second batter may further comprise artificial flavors and colors, and antioxidants to control rancidity. The second batter may contain approximately 2% to 10% by weight oil. In one embodiment, the second batter may contain up to about 5% by weight oil. Adding oil to the second batter may improve the finished batter coating appearance and improve batter coating release from Teflon™ slats, such as Cambridge™ belting or JBT ProGrill™/ProBake™ belting during further processing. In on embodiment, the dry ingredients may be identical to or substantially similar to the first and second predust formulation. The water content of the second batter may be adjusted depending on desired viscosity and coating thickness. The second batter may be applied to the food product by conventional procedures known in the art.

After the second batter has been applied to the food product, the battered coating of the food product may be set in a step 160. The food product from the second batter step 150 may then be removed and placed in a conveyor oven having a non-stick belt. The non-stick belt may comprise Teflon™ slats. Commercially available conveyor ovens may be employed to set the battered coating of the food product in step 160, such as, for example, the JBTPG Series ProGrill™/ProBake™ Contact Cooker. In one embodiment, the conveyor oven may be set at about 400° F. to about 450° F. and the food product may reside in the conveyor oven for approximately 2 minutes to set the batter coating with a combination of steam and dry heat. The batter coating may also be set in 100% steam.

After the setting step 160, the food product may be thermally processed in a cooking step 170. The food product may be thermally processed by any heating method such as baking, frying, microwaving, grilling, steaming, broiling, sous vide, etc. Commercially available contact cookers, such as, for example JBT ProGrill™/ProBake™ may perform step 170. The food product may be heated for a sufficient amount of time to fully cook the food product and to kill any harmful bacteria. In one embodiment, the food product may be fried in a deep fryer set at 350° F. for approximately 4 to 4.5 minutes, or until the food product registers an internal temperature of 165° F.

After the cooking step 170, the food product may be misted in a misting step 180. The battered coating of the food product may be sprayed by a top and bottom chilled water sprayer. In some embodiments, the food product is misted with a combination of vegetable oil, an emulsifier, and water.

Following the misting 180, the food product may be frozen and packaged in a step 190. The food product may be frozen after the misting step 180. The food product may be packaged in a polyethylene bag, vacuum packaged, or packaged in a modified atmosphere and hermetically sealed.

After the food product is frozen and packaged in step 190, the food product may be reheated. The food product may be reheated in a convection oven, deep fat fryer, pan, microwave, convection oven, infrared broiler, wok, flat grill, air fryer, or a combination thereof. In one embodiment, the frozen food product may be removed from its packaging and placed on a cookie sheet with a wire rack before being placed in an oven at 400° F. for approximately 18 to 20 minutes.

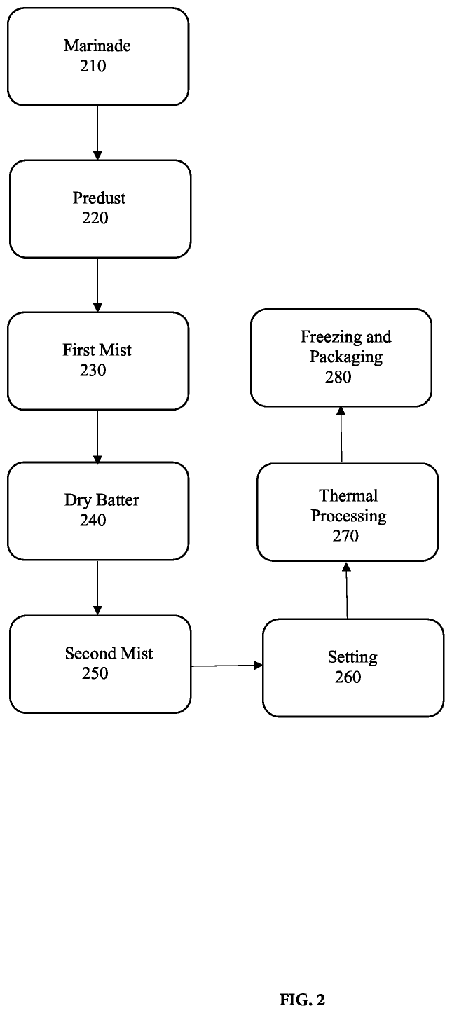

Referring now to FIG. 2, shown therein is a flowchart illustrating steps to coat a food product using a dry batter according to an exemplary embodiment of the inventive concepts disclosed herein.

In a step 210, a marinade is applied to a food product. The food product may be a meat, vegetable, fruit, appetizer, cheese, pasta-based food product, or a combination thereof. Generally, the size of the food product is not critical. The food products may vary from bite-sized to whole food products. The food product may also be a formed food product which is manufactured from particles of one or more food products and reformulated into particular shapes. The food product may be uniform in size or of varying sizes. The food product may also be portioned to a particular size. The food product may be fresh, frozen, or semi-frozen. The food product may be raw, cooked, or partially cooked, and may include a breaded heat set coating. The food product may be boneless or bone-in. In one embodiment, frozen food products are thawed to, for example, refrigerated temperature before the marination step 210.

The marinade applied to the food product in step 210 may impart flavor to the food product, tenderize the food product, and may introduce moisture into the food product to prevent the food product from becoming too dry once cooked. The marinade may also allow for uniformity of flavor of the food products. The marinade may be a liquid marinade, the composition of the liquid marinade may include liquid ingredients, dry ingredients, or both.

The liquid marinade may include a flavored stock, an alkali metal phosphate, and salt. The liquid marinade may contain a flavored stock, such as chicken stock, beef stock, turkey stock, vegetable stock, fish and seafood stock, bone broth, or a combination thereof. Flavored stock may impart flavor to the food product and provide moisture. The flavored stock for the liquid marinade may be salted or unsalted. The liquid marinade may comprise about 0% to 100% by weight of flavored stock. In one embodiment, the liquid marinade may comprise about 96% by weight of unsalted chicken stock. Stock powder, which has been reconstituted, may also be utilized in the liquid marinade.

The liquid marinade may contain alkali metal phosphates such as, for example, sodium tripolyphosphate, sodium hexametaphosphate, sodium pyrophosphate, dipotassium phosphate, or a combination thereof. The liquid marinade may comprise up to about 0.5% by food product weight of alkali metal phosphates. The liquid marinade may comprise about 0% to about 2% by weight of alkali metal phosphates. In one embodiment, the liquid marinade may comprise about 2% by weight of sodium tripolyphosphate. Sodium tripolyphosphate is commonly used in marinades to increase meat yield and water-holding capacity, as well as improve color and texture. The liquid marinade may also contain salt, such as sodium chloride. In some embodiments, the salt may be an encapsulated salt to better maintain the cellular integrity of meat proteins. The liquid marinade may comprise an amount of salt based on consumer preference. In one embodiment, the liquid marinade may comprise about 2% by weight of salt. Salt, similarly, is another common ingredient in marinades, and may enhance food product flavor, increase moisture retention, and, when used with sodium tripolyphosphate, may act as a synergist with sodium tripolyphosphate to extract salt-soluble proteins. The liquid marinade may be suitable for injection into food products. The marinade may be applied to the food product by conventional procedures known in the art, including the use of a vacuum tumbler, and needle injectors. The alkali metal phosphates and salt may be uniformly dispersed in the flavored stock to form the liquid marinade.

In one embodiment, the liquid marinade may further include sauces, spices, spice extractives, gums, and starches,

In one embodiment, marinating step 210 is performed in a vacuum tumbler. Vacuum tumbling is a method of marination in which food products are placed in a rotating tumbler in the presence of a marinade under reduced pressured. Applying a vacuum mechanically distorts the food product, expanding it, and allows for effective absorption of the marinade. Further, the mechanical distortion of the food product, such as meats, may break down meat fibers to enhance tenderization. Once the food products are placed into the vacuum tumbler, an amount of liquid marinade may be metered into the vacuum tumbler. An amount of liquid marinade of approximately 10% to 25% by weight of the food product may be placed into the vacuum tumbler with the food product. In one embodiment, an amount of liquid marinade, such as, about 13% by weight of the food product, may be metered into the vacuum tumbler. The food product may be tumbled in the vacuum tumbler for approximately 15-25 minutes. The food product may be marinated in the vacuum tumbler for a predetermined amount of time, or until substantially all the liquid marinade is absorbed by the food product.

In another embodiment, marinating step 210 may be optional.

In one embodiment, marinating step 210 may be performed by injecting the liquid marinade directly into the food product using, for example, a single needle injector or multi-needle injector. In that embodiment, the food product may be a bone-in meat product. The food product may be injected at one or more injection locations, and a desired volume of liquid marinade may be deposited at each of the one or more injection locations.

In another embodiment, after marinating step 210, the food product may be placed on a vibratory conveyor belt, which produces a vibration, or otherwise agitates the food products as the food products are being conveyed along the vibratory conveyor belt, causing the liquid marinade to be uniformly dispersed throughout the food product.

After the marination step 210, a predust may be applied to the food product in a step 220.

In step 220, a predust may be added to the vacuum tumbler to coat the food product after the marination step 210. Application of a predust to the food product may improve the adhesion of a coating, improve yield, impart flavor, and improve crispiness of a food product. The predust may contain one or more of bread crumbs, cracker meal, food starch, fiber, flour, spices, natural colors and flavors, and oil. The predust may include bread crumbs, such as American bread crumbs or Japanese bread crumbs. The bread crumbs and cracker meal may contribute to the food product's ultimate texture, flavor, and appearance. The bread crumbs may be sauteed to impart a refined sauté fried flavor and golden-brown appearance to the food product. In one embodiment, bread crumbs may be sautéed with oil using a heated plate with a surface temperature of about 400° F. The oil may be a vegetable oil, an animal fat or oil, or combination thereof. The oil may be a soy bean oil, cotton seed oil, palm kernel oil, safflower oil, corn oil, beef tallow, pork lard, goose or duck fat, or a combination thereof. The predust may also contain wheat flour, tapioca flour, rice flour, yellow corn flour or a combination thereof. Commercially available mixers, such as, for example, OptimaBlend® blenders may perform step 220. Food starch, such as natural starches, may be included in the predust for added crispiness and for improve oil-barrier properties. Similarly, natural colors may be added to the predust composition to create a uniform golden color around the food product. The predust may be formed by combining the bread crumbs, cracker meal, food starch, fibers, flour natural flavors and colors, spray dried fats, flavored meat powders, and spices. In some embodiments, the first predust may further comprise artificial flavors and colors, and antioxidants to control rancidity. The combined predust may be processed to obtain varying particle sizes. In one embodiment, the predust is a fine powder with limited bread crumbs and cracker meal.

An amount of predust may be metered into the vacuum tumbler to coat the marinated food product. In one embodiment, an amount of predust, such as, about 0% to about 2% by weight of the food product, may be metered into the vacuum tumbler. The food product may be tumbled in the vacuum tumbler with the predust for up to about 5 minutes. The food product may be coated with the predust in the vacuum tumbler for a predetermined amount of time, or until substantially all of the predust has adhered to the surface of the food product.

In an alternative embodiment, the liquid marinade and predust may be applied to the food product without a vacuum tumbler using conventional methods.

In another embodiment, the predust step 220 may be optional.

After the predust step 220, the food product may be removed from the vacuum tumbler and placed on a vibratory conveyor and may be misted in a first misting step 230. The food product may be sprayed with a combination of vegetable oil and water. Misting the food product with a blend of vegetable oil and water following the predust step 220 may improve the adhesion of a coating, improve yield, impart flavor, and improve crispiness of the food product. In one embodiment, the food product may be misted with a combination of vegetable oil, water, and an emulsifier. In another embodiment, the food product may be misted with water.

In a step 240, a dry batter may be applied to the food product. The dry batter may include a combination of dry ingredients. The dry batter may contain one or more of bread crumbs, food starch, flour, cracker meal, natural flavors and colors, spices, spray dried fats, flavored meat powders, and combinations thereof. The dry batter may contain bread crumbs, such as American or Japanese bread crumbs. The dry batter may also contain one or more varieties of flour, such as wheat flour, tapioca flour, rice flour, yellow corn flour, or a combination thereof. The dry batter may also contain, for example, natural starches, citrus fibers, natural flavors and colors, spices, spray dried fats, flavored meat powders, or a combination thereof. In some embodiments, the dry batter may further comprise artificial flavors and colors, and antioxidants to control rancidity.

In one embodiment, the dry batter may further contain oil. In that embodiment, the dry batter may contain about 2% to about 5% by weight oil. The addition of oil to the dry batter may improve the finished batter coating appearance and improve batter coating release from Teflon™ slats, such as Cambridge™ belting or JBT ProGrill™/ProBake™ belting during further processing. In on embodiment, the dry ingredients may be identical to or substantially similar to the predust formulation. The dry batter may be applied to the food product by conventional procedures known in the art.

After the dry batter has been applied to the food product, the food product may be misted in a second misting step 250 to form an edible coating on the food product. The food product may be sprayed with a combination of vegetable oil, water, and an emulsifier. The combination of the vegetable oil, water, and the emulsifier facilitate the creation of a battered coating on the food product. More particularly, the combination of vegetable oil, water, and the emulsifier promotes the agglomeration of certain components of the dry batter, which results in the formation of a battered coating on the food product. In one embodiment, the vegetable oil, water, emulsifier blend may comprise about 60% to about 80% by weight vegetable oil, 20% to about 40% by weight water, and 0.01% by weight an emulsifier. In one embodiment the emulsifier is a monoglyceride, diglyceride, or a combination thereof. In one embodiment, the combination of the vegetable oil, water, and the emulsifier form an oil-in-water emulsion.

The food product from the second misting step 250 may then be removed and placed in a conveyor oven having a non-stick belt. The non-stick belt may comprise Teflon™ slats. Commercially available conveyor ovens may be employed to set the battered coating of the food product in step 260, such as, for example, the JBTPG Series ProGrill™/ProBake™ Contact Cooker. In one embodiment, the conveyor oven may be set at about 355° F. to about 450° F. and the food product may reside in the conveyor oven for approximately 2 minutes to set the batter coating with a combination of steam and dry heat. The batter coating may also be set in 100% steam.

After the setting step 260, the food product may be thermally processed in a cooking step 270. The food product may be thermally processed by any heating method such as baking, frying, microwaving, grilling, steaming, broiling, sous vide, etc. Commercially available contact cookers, such as, for example JBT ProGrill™/ProBake™ may perform step 270. The food product may be heated for a sufficient amount of time to fully cook the food product and to kill any harmful bacteria. In one embodiment, the food product may be fried in a deep fryer set at 350° F. for approximately 4 to 4.5 minutes, or until the food product registers an internal temperature of 165° F.

After the cooking step 270, the food product may be misted in a third misting step 180. The battered coating of the food product may be sprayed by a top and bottom chilled water sprayer. In some embodiments, the food product is misted with a combination of vegetable oil, an emulsifier, and water.

Following the misting 280, the food product may be frozen and packaged in a step 290. The food product may be frozen after the misting step 280. The food product may be packaged in a polyethylene bag, vacuum packaged, or packaged in a modified atmosphere and hermetically sealed.

After the food product is frozen and packaged in step 290, the food product may be reheated. The food product may be reheated in a convection oven, deep fat fryer, pan, microwave, convection oven, infrared broiler, wok, flat grill, air fryer, or a combination thereof. In one embodiment, the frozen food product may be removed from its packaging and placed on a cookie sheet with a wire rack before being placed in an oven at 400° F. for approximately 18 to 20 minutes.

From the above description, it is clear that the inventive concepts disclosed herein are adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the scope of the inventive concepts disclosed herein and defined by the appended claims.

What is claimed is:

1. A process for preparing a battered food product, comprising:
coating a food product with a predust comprising cracker meal, and one or more natural coating ingredients in a predust step;
misting the food product from the predust step with water and oil in a first misting step;
coating the food product from the first misting step with a dry batter in a coating step, the dry batter comprising dry ingredients and oil;
misting the food product from the coating step with a water, oil, and an emulsifier in a second misting step to form an edible coating on the food product;
setting the edible coating on the food product in a steam oven in a setting step;
thermally processing the food product from the setting step in a cooking step;
misting the edible coating on the food product from the cooking step with water in a third misting step; and
freezing the food product from the third misting step for packaging.

2. The process of claim 1, further comprising a step of coating the food product with a liquid marinade in an initial marinating step prior to the first predust step.

3. The process of claim 2, wherein the food product is coated with the liquid marinade in a vacuum tumbler.

4. The process of claim 2, wherein the liquid marinade includes one or more of a stock, an alkali metal phosphate, and salt.

5. The process of claim 4, wherein the liquid marinade further includes one or more of a sauce, flavorings, spices, spice extractives, gums, and starches.

6. The process of claim 4, wherein the stock is selected from a group consisting of chicken stock, beef stock, turkey stock, vegetable stock, fish and seafood stock, bone broth, water, and a combination thereof.

7. The process of claim 4, wherein the flavored stock is unsalted.

8. The process of claim 4, wherein the flavored stock is unsalted chicken stock.

9. The process of claim 4, wherein the alkali metal phosphate is selected from a group consisting of sodium tripolyphosphate, sodium hexametaphosphate, sodium pyrophosphate, dipotassium phosphate, and a combination thereof.

10. The process of claim 4, wherein the alkali metal phosphate is sodium tripolyphosphate.

11. The process of claim 4, wherein the weight ratio of the flavored stock, alkali metal phosphate, and salt is about 48:1:1.

12. The process of claim 1, wherein the food product is coated with the predust in the vacuum tumbler.

13. The process of claim 1, wherein the predust step further includes sautéing the cracker meal with an oil.

14. The process of claim 13, wherein the cracker meal is sauteed using a heated plate with a surface temperature of approximately 400° F.

15. The process of claim 1, wherein the one or more natural coating ingredients are selected from a group consisting of natural starches, citrus fibers, wheat flour, tapioca flour, rice flour, yellow corn flour, natural flavors and colors, spices, spray dried fats, flavored meat powders, oil, and a combination thereof.

16. The process of claim 1, wherein one or more of the predust and the dry batter further comprise artificial flavors and colors.

17. The process of claim 1, wherein the dry batter includes 5% by weight oil.

18. The process of claim 1, wherein the emulsifier is a monoglyceride, diglyceride, or a combination thereof.

19. The process of claim 1, wherein thermally processing the food product includes at least one of baking, frying, microwaving, grilling, steaming, sous vide, or broiling the food product.

20. The process of claim 1, wherein thermally processing the food product includes frying the food product in a fryer such that the internal temperature of the food product is at least about 165° F.

21. The process of claim 1, further comprising a step of reheating the food product following the freezing step.

22. The process of claim 21, wherein the step of reheating the food product following the freezing step includes at least one of heating the food product in a convection oven, a deep fat fryer, a pan, a microwave, a convection oven, an infrared broiler, a work, a flat grill, or an air fryer.
